(19) United States
(12) Patent Application Publication
(10) Pub. No.: US 2007/0036746 A1
(43) Pub. Date: Feb. 15, 2007

(54) Water-degradable fishing lure

(76) Inventors: Roger D. Hester, Daphne, AL (US); Russell W. Hanson, Livingston, AL (US)

Correspondence Address: KILYK & BOWERSOX, P.L.L.C., 400 HOLIDAY COURT, SUITE 102, WARRENTON, VA, 20186, US

(21) Appl. No.: 11/503,495

(22) Filed: Aug. 11, 2006

Related U.S. Application Data
(60) Provisional application No. 60/707,782, filed on Aug. 12, 2005.

(51) Int. Cl. A01N 25/00; A01K 85/00

(52) U.S. Cl. 424/84; 43/42

(57) ABSTRACT

A fishing lure that is water-degradable is described. The fishing lure can be a polymeric fishing lure. The fishing lure can have a body that includes at least one hydrophilic polyester or copolyester and at least one plasticizer and wherein the body is degradable upon immersing the body in water a body.

This application claims the benefit under 35 U.S.C. §119(e) of prior U.S. Provisional Patent Application No. 60/707,782, filed Aug. 12, 2005, which is incorporated in its entirety by reference herein.

### FIELD OF THE INVENTION

The present invention relates to a water-degradable fishing lure. In particular, the present invention relates to a fishing lure that retains acceptable physical properties over a period of use and immersion in water, but that has the property of decomposing over time.

### BACKGROUND OF THE INVENTION

Most artificial fishing lures are currently produced from synthetic non-degradable polymer composites. These polymer composites are typically made from silicon rubber or polyvinylchloride that is mixed with low molecular weight plasticizers. Unfortunately, these lures do not degrade when they are discarded into the environment, and thus become aquatic pollutants. Also, if a fish consumes a released lure, the lure will remain undigested in its gastrointestinal tract and will block its normal digestion of food. This stunts fish growth and could eventually kill the fish. As the number of fishermen increase, the above problems will magnify and artificial non-degradable synthetic lures will become more unacceptable.

Degradable fishing lures produced from natural and/or food grade ingredients have been developed and are commercially available. These lures degrade in water, but have disadvantages that have limited their acceptance by fishermen. Most sport and commercial fishermen will not accept degradable fishing lures unless, during short-term water exposure, they have physical properties similar to existing non-degradable artificial fishing lures. In particular, degradable fishing lures from natural or food grade ingredients may lack one or more of the following physical properties: (1) high flexibility and elasticity for proper lure movement through the water, (2) toughness and cohesive strength that enables a hook to be retained after the lure is repeatedly stressed from water impacts during castings and water drag forces during trolling, and (3) a surface topology that mimics the feel and appearance of live baits. In addition, the properties of a degradable fishing lure should not rapidly change when it is removed from its packaging or during several hours of fishing. Food based artificial lures may be perishable on long term storage and typically, either lose water on air exposure and become brittle or absorb water on water immersion and quickly become too soft to be acceptable fishing lures.

Accordingly, there is a need to provide a fishing lure that has the properties of high flexibility and elasticity for proper lure movement through the water, toughness and cohesive strength that enables a hook to be retained after the lure is repeatedly stressed from water impacts during castings and water drag forces during trolling, and a surface topology that mimics the feel and appearance of live baits and that degrades after prolonged exposure to water.

Further, there is a need to provide a fishing lure that degrades after prolonged exposure to water and that is a composite of different materials that can be selected to provide a desired degree of flexibility, elasticity, hardness, toughness, cohesive strength and slippery feel. Further, there is a need to provide a fishing lure that contains a fish attractant that can be released gradually during exposure to water.

Further, there is a need to provide a water-degradable fishing lure that is stable during long term storage.

### SUMMARY OF THE INVENTION

A feature of the present invention is to preferably provide a fishing lure that has the properties of high flexibility and elasticity for proper lure movement through the water, toughness and cohesive strength that enables a hook to be retained after the lure is repeatedly stressed from water impacts during castings and water drag forces during trolling, and a surface topology that mimics the feel and appearance of live baits and that degrades after prolonged exposure to water.

Another feature of the present invention is to provide a fishing lure that contains a fish attractant that can be released gradually during exposure to water.

Still another feature of the present invention is to provide a fishing lure wherein the degree of flexibility, elasticity, hardness, toughness, cohesive strength and slippery feel of the body of the fishing lure may be controlled during manufacture.

Additional features and advantages of the present invention will be set forth in the description which follows, and, in part, will be apparent from the description, or may be learned by practice of the present invention. The features and other advantages of the present invention will be realized and attained by means of the elements and combinations particularly pointed out in the written description and the claims.

To achieve these and other advantages, and in accordance with the purposes of the present invention as embodied and broadly described herein, the present invention relates to a fishing lure that comprises a body made up of at least one polyester, such as at least one copolyester, like at least one aliphatic-aromatic copolyester, and at least one plasticizer and wherein the body is degradable upon immersing the body in water for a period of time. The body may further contain a fish attractant and/or other ingredients.

The body of the fishing lure may include more than one polymer, including more than one polyester, or copolyester, or aliphatic-aromatic copolyester. For example, the body of the fishing lure may include copolyesters of differing composition and molecular weight, so that properties of the fishing lure may be selected by selecting the ratio of copolyesters or by selecting the ratio of copolyesters to plasticizer. For example, the body of the copolymer may include a first aliphatic-aromatic copolyester of a first defined average molecular weight and a second aliphatic-aromatic copolyester of second defined average molecular weight, wherein the first molecular weight is at least 25% greater than the second molecular weight. As a non-limiting example, the first aliphatic-aromatic copolyester may be a copolyester of polybutylene terephthalate and a polyether glycol and the second copolyester may be a polyethylene terephthalate copolymer. The body of the fishing lure may also include or alternatively include a branched polyester containing ionic moieties, such as a sulfonated copolyester. As non-limiting examples, the plasticizer may be a citric acid ester or a hydrogenated wood rosin ester, and the at least one fish attractant may be hydrolyzed fish protein, fish oil, fish meal, ground crustaceans, ground mussels, fish powder, fruit, spices, garlic, garlic oil, glitter materials, and/or coloring agents. For example, the fish attractant may have a scent that is released in active form upon immersing the body in water.

The physical properties of the fishing lure may be modified by selecting the ratio of the components that make up the body of the fishing lure. For example, the rate at which the body of the fishing lure degrades upon immersion of the body in water and the rate at which the fish attractant is released in active form may be selected by selecting the relative amounts of the first aliphatic-aromatic copolyester, the second aliphatic-aromatic copolyester, the branched copolyester containing ionic moieties, the at least one plasticizer, and the fish attractant.

In another aspect, the present invention is directed to a fishing lure that contains a water-degradable body having an initial tensile strength at break of from 40 to 50 psi, an initial tear strength of from 3.5 to 4.0 lb_{f}/inch, an initial modulus at 10% elongation of from 110 to 125 psi, an initial elongation at break of from 120 to 130%, an initial torsional modulus of from 7.0 to 15 psi, and/or an initial energy to break of from 0.40 to 0.45 in-lb_{f}. The fishing lure preferably degrades slowly in water so that after the body is immersed in fresh water (but can be salt water) at an ambient temperature (e.g., 25° C.) for 24 hours, the body has a tensile strength at break of from 35 to 50 psi, a tear strength of from 2.2 to 3.5 lb_{f}/inch, a modulus at 10% elongation of from 105 to 130 psi, an elongation at break of from 80 to 120%, an energy to break of from 0.35 to 0.4 lb_{f}/inch, and/or a torsional modulus of from about 6 to about 16 psi. However, after prolonged immersion in water, the fishing lure begins to completely degrade so that after the body is immersed in fresh water at an ambient temperature (e.g., 25° C.) for 2600 hours, the body has a tensile strength at break of 45 psi or less, a tear strength of 3.3 lb_{f}/inch or less, a modulus at 10% elongation of 115 psi or less, an elongation at break of 95% or less, an energy to break of 0.34 lb_{f}/inch or less, and/or a torsional modulus of from about 12 psi or less. The physical parameters herein are measured based on ASTM standards, and in particular, the ASTM standards identified specifically in the examples.

It is to be understood that both the foregoing general description and the following detailed description are exemplary and explanatory only and are intended to provide a further explanation of the present invention, as claimed.

### BRIEF DESCRIPTION OF THE DRAWING

FIG. 1 is a table showing the physical properties of various lure compositions of the present invention before exposure to water.

### DETAILED DESCRIPTION OF THE PRESENT INVENTION

The present invention relates to a fishing lure that is water-degradable over time, such as within 1 month, 3 months, 6 months, or 1 year (e.g., 6 months to 1 year or more) or more. The fishing lure is generally synthetic, such as polymeric in nature, and can contain one or more additional components that are polymeric or non-polymeric. The fishing lure is preferably not degradable outside of water and, therefore, is preferably not biodegradable from the standpoint of degrading in air. Though, a water-degradable fishing lure may be degradable in soil, though at a slower degrading period, and depending on such factors as the amount of moisture in the ground. The fishing lure is preferably non-toxic to the water environment and preferably each component of the fishing lure is non-toxic. In one aspect, the present invention relates to a fishing lure that comprises a body containing at least one polyester (e.g., at least one copolyester or at least one aliphatic-aromatic copolyester) and at least one plasticizer and wherein the body is degradable upon immersing the body in water.

The polyester(s) are preferably hydrophilic. The polyester or copolyester is preferably water-degradable, such as water-degradable over time. For example, the aliphatic-aromatic copolyester according to the present invention is typically a linear copolyester that contains both aliphatic and aromatic blocks, which may be in any order, including alternating, sequential, block or random order. Aliphatic-aromatic copolyesters that may be used in the present invention include polybutylene terephthalate and polyethylene glycols copolyesters. Examples of aliphatic-aromatic copolyesters include condensation products of an aromatic diacid, such as, for example, a terephthalate, and an aliphatic diol, such as, for example, 1,2-ethanediol, 1,3-propanediol, 1,4-butanediol and/or 1,6-hexanediol. Examples of aliphatic-aromatic copolyesters and methods of preparation may be found, for example, in U.S. Pat. No. 5,446,079, incorporated in its entirety by reference herein. Typical aromatic monomers may include polybutylene terephthalate. Typical aliphatic monomers may include polyether glycol. The physical properties of the polyester, e.g., aliphatic-aromatic copolyester, can be controlled by selecting the molecular weight of the polyester and, for instance, by selecting the relative molar amount of aliphatic and aromatic units. For example, a greater hardness, tensile break strength and tear strength but a reduced flexibility and elasticity may be obtained by increasing the molecular weight of the aliphatic-aromatic copolyester. Further, the water-degradability of the copolyester may be increased by increasing the aliphatic content, whereas the tensile break strength and tear strength may be increased by increasing the aromatic content.

Aliphatic-aromatic copolyesters with a range of properties are commercially available. For example, Hytrel® elastomers, which are aliphatic-aromatic copolyesters including polybutylene terephthalate and polyether glycol, and Biomax® polymers, which are aliphatic-aromatic copolyesters based on polybutylene terephthalate are available from DuPont, Wilmington, Del. Other commercially available copolyesters include the AQ® polymers available from Eastman Chemical Co., Kingsport, Tenn.

Moreover, the body of the fishing lure may contain more than one type of aliphatic-aromatic copolyester. For example, the body of the fishing lure may contain a first aliphatic-aromatic copolyester of a first defined average molecular weight and a second aliphatic-aromatic copolyester of second defined average molecular weight, wherein the first molecular weight is at least 25% greater than the second molecular weight (e.g., from about 25% to about 50% greater). The first and second aliphatic-aromatic copolyesters may have the same or different monomer composition. Having two different molecular weights for the first and second polyesters allows for adjustment of properties such as flexibility, elasticity, hardness, tear strength and/or tensile strength by selecting the relative amount of each polymer. In particular, increasing the amount of the lower molecular weight copolyester reduces the material's hardness, tensile break strength and/or tear strength but increases flexibility and/or elasticity. As an example, the first aliphatic-aromatic copolyester may have an average molecular weight ranging from about 3,000 to about 6,000 and the second aliphatic-aromatic copolyester may have an average molecular weight ranging from about 8,000 to about 20,000.

As a specific non-limiting example, the first aliphatic-aromatic copolyester may be Hytrel® 8171 copolyester available from DuPont, Wilmington, Del. The second aliphatic-aromatic copolyester may be Biomax® 4026 copolyester, also provided by DuPont, Wilmington, Del.

The body of the fishing lure also includes at least one plasticizer. The plasticizer is preferably non-toxic. The plasticizer is compatible with the polyester. For example, the plasticizer may be a biodegradable, low molecular weight plasticizer, such as a plasticizer typically used for polyesters. Plasticizers that may be used in the present invention include citric acid esters, methyl esters of hydrogenated rosins, and dipropylene glycol dibenzoate. In particular, the plasticizer preferably may be a non-toxic plasticizer such as a citric acid ester or a wood rosin ester. An example of a commercially available citric acid ester is a Citroflex® citric acid ester available from Morflex, Inc., Greensboro, N.C. An example of a commercially available wood rosin ester is a Hercolyn® methyl ester of hydrogenated rosin produced by Pinova, Brunswick, Ga.

Selection of the relative amount of polyesters and plasticizers in the body of the fishing lure provides an additional way to control the flexibility, elasticity, hardness, tear strength and tensile strength of the body of the fishing lure. In particular, using a larger amount of plasticizers reduces the material's hardness, tensile break strength and tear strength but increases flexibility and elasticity. Further, the rate of decomposition of the body of the fishing lure when it is immersed in water may be controlled by varying the weight ratio of total polyester to plasticizer, with a greater amount of plasticizer increasing the decomposition. For example, the weight ratio of total polyester weights to total plasticizer weights may range from 2/3 to 3/2 and preferably ranges from 8/10 to 12/10. Other weight ratios can be used.

The body of the fishing lure may also include at least one fish attractant. The fish attractant can be any material that is capable of attracting fish to the lure, such as, for example, a visual attractant, a scent attractant, a food attractant, a feeding stimulant, or a combination of any of these. Examples include, but are not limited to, hydrolyzed fish protein, fish oil, fish meal, ground crustaceans, ground mussels, fish powder, fruit, spices, garlic, garlic oil, extracts, glitter materials (e.g., metallic and/or polymeric glitter), and/or coloring agents (e.g., food grade colors, like dyes). Preferably, the fish attractant is a scent that is homogeneously present in or distributed throughout the body of the fishing lure. The fish attractant can be released in active form when the body of the fishing lure is immersed in water. The body of the fishing lure can contain visual attractants such as glitter and coloring agents. The fish attractant can be present in an amount of from 0.1 wt % to 16 wt % or more, based on the overall weight of the lure.

The fish attractant may be a substance that also has properties of a plasticizer. For example, a fish oil such as menhaden oil can serve as both a plasticizer and a fish attractant. As a specific, non-limiting example, a menhaden fish oil plasticizer/fish attractant is commercially available from Glory-Hole Fishing Products, Boyd, Tex.

The body of the fishing lure may contain as a polyester or, in addition, at least one branched copolyester that contains ionic moieties. For example, the branched copolyester may be a branched aliphatic-aromatic polyester that has randomly distributed pendant sodiosulfo groups. A specific, non-limiting example of a water dispersible branched copolyester containing ionic moieties is a sulfonated copolyester such as the AQ® copolyesters produced by Eastman Chemical Co., Kingsport, Tenn. Specific, non-limiting examples of branched sulfonated copolyesters are Eastman AQ® 1950 (a low molecular weight polymer) and Eastman AQ® 14000 (a high molecular weight polymer).

The mechanical, tactile and water degradable properties of the fishing lure can be controlled by selecting the monomer composition, molecular weights of the polyesters, and in the preferred embodiment, the relative amounts of each aliphatic-aromatic copolyester, the plasticizer, the branched copolyester containing ionic moieties, if present and the fish attractant(s), if present. For example, in an embodiment containing only one aliphatic-aromatic copolyester, the mechanical, tactile, and water degradable properties of the fishing lure may be controlled by selecting the relative aromatic content and aliphatic content of the copolymer. In particular, as discussed above, increasing the relative aromatic content of the copolyester increases the hardness, tensile break strength, and tear strength, but decreases flexibility, elasticity, and degradability and, by reducing the rate of hydration, lessens the desirable slippery feel of the material. Moreover, for a given copolyester, providing a higher molecular weight copolyester increases the material's hardness, tensile break strength, and tear strength, but decreases the flexibility and elasticity.

Moreover, the mechanical, tactile, and water degradable properties of the fishing lure can be controlled by selecting the relative amount of copolyester and plasticizer (including any amount of fish attractant that also acts as a plasticizer). Increasing the relative amount of the copolyester increases the hardness, tensile break strength, and tear strength, but decreases flexibility, elasticity, and degradability and, by reducing the rate of hydration, lessens the desirable slippery feel of the material.

The use of more than one type of polyester (e.g., copolyester, like aliphatic-aromatic copolyester) allows for similar control to be exercised over the mechanical, tactile, and water degradable properties of the fishing lure using a combination of polyesters or copolyesters, such as commercially available copolyesters. For example, the relative amount of a high molecular weight polyester and a low molecular weight polyester can be selected to fine-tune the material to achieve the desired properties. Increasing the relative amount of a high molecular weight polyester increases the hardness, tensile break strength, and tear strength, but decreases flexibility, elasticity, and biodegradability and, by reducing the rate of hydration, lessens the desirable slippery feel of the material. As a specific, non-limiting example, increasing the relative amount of a relatively high molecular weight aliphatic-aromatic copolyester, such as a polybutylene terephthalate/polyether glycol Hytrel® elastomer, slows the rate of degradation of the fishing lure when immersed in water, thereby allowing the useful life of the fishing lure to be extended, and improves the stability of the fishing lure for long-term storage prior to use or between periods of use. Increasing the relative amount of a branched copolyester containing ionic moieties, such as an AQ® copolyester, increases the hygroscopic properties of the fishing lure and improves the tactile qualities of the material, such as the desirable slippery feel.

The ability to select and fine-tune particular properties by selecting polyesters and their relative amounts is particularly useful to obtain an acceptable combination of various properties. Particularly, selections may have an inverse effect on many of the physical properties, such that a certain amount of compromise may be necessary. For example, as discussed above, making a selection that increases the hardness, tensile break strength and tear strength of the material tends to decrease the flexibility, elasticity, biodegradability and slippery feel of the material. The materials for the body of the fishing lure may be selected so that the fishing lure is flexible and elastic enough to provide proper lure movement through the water in a matter that is realistic and attractive to fish. The material may be selected to provide toughness and cohesive strength so that a hook is retained by the lure, even after the material is stressed by repeated water impacts during casting and is subjected to water drag forces during trolling. The material may be selected to provide a surface topology that mimics the slippery feel and appearance of a live bait. As an example, materials for the body of the fishing lure may be selected to obtain a material that that has properties of an initial tensile strength at break of from about 60 psi to about 10 psi, an initial tear strength of from about 6.0 to about 0.2 lb_{f}/inch, an initial modulus at 10% elongation of from about 130 to about 20 psi, an initial elongation at break of from about 150 to about 40%, and/or an initial energy to break of from about 0.6 to about 0.01 in-lb_{f}, or any combination thereof. The rate of degradability of the body of the fishing lure may be controlled so that these properties are retained during normal use of the fishing lure. For example, the tensile strength at break after the body is immersed in fresh water at an ambient temperature for 24 hours may be within about 100% to about 90% of the initial tensile strength at break. The tear strength after the body is immersed in fresh water at an ambient temperature for 24 hours may be within about 90% to about 60% of the initial tear strength. The modulus at 10% elongation after the body is immersed in fresh water at an ambient temperature for 24 hours may be within about 80% to about 120% of the initial modulus at 10% elongation. The elongation at break after the body is immersed in fresh water at an ambient temperature for 24 hours may be within about 60% to about 75% of the initial elongation at break. The energy to break after the body is immersed in fresh water at an ambient temperature for 24 hours may be within about 80% to about 100% of the initial energy to break. The torsional modulus after the body is immersed in fresh water at an ambient temperature for 24 hours may be within about 80 to 120% of the initial torsional modulus. Further, the hydration and degradability of the material can be selected to control the rate at which a fish attractant is released after the body is immersed in water. For example, the percent content of fish attractant after the body is immersed in fresh water at an ambient temperature for 24 hours may be within about 80% to about 90% of the initial percent content of fish attractant.

The rate of degradability of the body of the fishing lure may be controlled so that after the fishing lure has been immersed for a substantial period of time, such as after the fishing lure has broken off and become lost, the body of the fishing lure begins to completely degrade. For example, the tensile strength at break after the body is immersed in fresh water at an ambient temperature for 2600 hours may be within from about 90% to about 80% of the initial tensile strength at break. The tear strength after the body is immersed in fresh water at an ambient temperature for 2600 hours may be within from about 50% to about 20% of the initial tear strength. The modulus at 10% elongation after the body is immersed in fresh water at an ambient temperature for 2600 hours may be within from about 90% to about 80% of the initial modulus at 10% elongation. The elongation at break after the body is immersed in fresh water at an ambient temperature for 2600 hours may be within from about 70% to about 80% of the initial elongation at break. The energy to break after the body is immersed in fresh water at an ambient temperature for 2600 hours may be within from about 70% to about 80% of the initial energy to break. The torsional modulus after the body is immersed in fresh water at an ambient temperature for 2600 hours may be within from about 60% to 90% of the initial torsional modulus. The percent content of fish attractant after the body is immersed in fresh water at an ambient temperature for 2600 hours may be within from about 60% to about 70% of the initial percent content of fish attractant.

In one or more embodiments of the present invention, one or more of the fishing lure physical properties may initially increase after so many hours, such as after 10 to 300 hours. One or more of the properties may increase initially due to the water displacing the oil plasticizer in the fishing lure, wherein the water may act as a type of plasticizer which will actually cause toughening of the fishing lure, such as through hydrogen bonding. Ultimately, once hydrolysis starts occurring and the polymer begins to break down, the one or more of the physical properties and preferably all of the physical properties will begin to decrease and, over time, dramatically decrease from the initial physical properties of the fishing lure prior to being placed in water. Thus, in one or more embodiments of the present invention, the one or more physical properties of this fishing lure may increase initially for several hours and then ultimately decrease after additional hours and ultimately degrade in the water. In one embodiment of the present invention, one or more of the initial physical properties, such as initial tensile strength at break, initial tear strength, initial modulus at 10% elongation, initial elongation at break, initial energy to break, and/or initial torsional modulus can decrease by 5% to 10% or more once immersed in fresh water at a temperature of 25° C. for 100 hours to 500 hours or more. The percent of degradation of at least one or more of these physical properties can be on the order of 10% to 50%, or 5% to 50%, or 10% to 25%, or 10% to 35% of the one or more of the initial physical properties of the fishing lure after being immersed in fresh water at 25° C. for 100 hours to 500 hours or more (e.g., 100 hours to 400 hours, 100 hours to 300 hours, 100 hours to 200 hours, 100 hours to 750 hours, 300 hours to 750 hours, 300 hours to 1,000 hours, 300 hours to 2,000 hours, 500 hours to 3,000 hours, and the like). Preferably, at least two of the physical properties, at least three of the physical properties, at least four of the physical properties, at least five of the physical properties, or all six of the physical properties can decrease by these percentages over time to ultimately lead to a water-degraded product in the water.

As a non-limiting example, the body of a fishing lure according to the present invention may comprise a first polyester (e.g., a first copolyester, like a first aliphatic-aromatic copolyester) in an amount of from about 0% to about 25% by weight, a second polyester (e.g., a second copolyester, like a second aliphatic-aromatic copolyester) in an amount of from about 0% to about 15% by weight, a branched polyester containing ionic moieties in an amount of from about 0% to about 35% by weight, a plasticizer in an amount of from about 25% to about 45% by weight and a fish attractant in an amount of from about 0% to about 15% by weight.

The fishing lure may be manufactured by any method for combining at least one polyester and at least one plasticizer, such as, for example, conventional polymer melt processing techniques. For example, the ingredients or components that make up the body of the fishing lure can be mixed together in any order by any means, such as mixing at an elevated temperature to form a homogeneous thermoplastic material. For example, the components may be mixed at a temperature of from about 200° C. to about 220° C. for from about 15 minutes to about 30 minutes or for any other period of time, for example, sufficient to create a homogeneous mixture. The mixed components may be formed into any shape, particularly into any shape suitable for use as a fishing lure. For example, the fishing lure may be in any shape that mimics a natural food of a fish, such as a minnow, worm, shrimp, crayfish, squid, crab, water flea, plant, fruit, and the like. The fishing lure may be in any other shape that may draw the attention of a fish. The fishing lure may be formed by any suitable method such as extrusion or molding, for example. As a non-limiting example, the ingredients of the body of the fishing lure may be melt mixed in a co-rotating twin screw extruder at 210° C. and then molded into a particular shape, such as a worm shape. The material can be used in an injection molding machine to produce any lure shape or size. At the time of molding, additional coloring agents may be added to improve the simulation of a particular natural food of a fish. The fishing lure may also include an hook or a line attachment fastened onto or incorporated into the body of the fishing lure and may include additional features such as streamers or simulated fish eyes, for example, to attract the attention of fish.

Typically, the body of the fishing lure of the present invention has a density that is slightly greater than water. The body of the fishing lure may be made less dense by infusing air cavities into the material of the fishing lure during manufacturing, and may be made more dense by adding a filler such as a high density inorganic filler. Examples of various densities are from 0.8 sp. gravity to 1.25 sp. gravity.

The body of the fishing lure may also contain additives such as stabilizers and UV protection agents so that the fishing lure does not degrade during normal exposure to sunlight, such as during storage prior to use.

The present invention will be further clarified by the following examples, which are intended to be exemplary of the present invention.

### EXAMPLES

### Example 1

A composite lure material was made by melt mixing, in a co-rotating twin screw extruder at 210° C., 20 weight parts of Hytrel® 8171 copolyester and 6 weight parts of Biomax® 4026 copolyester, provided by DuPont, Wilmington, Del., 26 weight parts of AQ® WDP-95 copolyester, provided by Eastman Chemical Co., Kingsport, Tenn., 33.6 weight parts of Citroflex® C2 citric acid ester plasticizer, provided by Morflex, Inc., Greensboro, N.C., and 14.4 weight parts of menhaden fish oil coplasticizer and fish attractant provided by Glory-Hole Fishing Products, Boyd, Tex. The composite material was molded into ⅜ inch diameter by five inch long worm-like fishing lures and 1/16 inch thick by 5 inches in diameter flat, circular disks.

The circular disks were used to make physical test samples. Using ASTM test method D412, the composite elongation at break, tensile strength at break, energy to break and modulus at 10% elongation were found to be 127%, 49 psi, 0.43 lb_{f} per inch and 112 psi, respectively. Using ASTM test method D624, the composite tear strength was found to be 3.8 pounds force per inch of thickness. Using ASTM test method D2240, the composite hardness was found to have a type A Durometer value of 10. Using ASTM test method D1053, the composite torsional modulus, a measure of flexibility, was found to be 7.5 psi. These properties correlate with what is desired to have a lure with the feel, flexibility, elasticity and hook setting properties needed for fishing.

Table I shows the changes in composite physical properties after prolonged storage in sealed 5 mil thickness polyethylene plastic bags.

TABLE I
Changes in Composite Physical Properties after Storage in Plastic Bags

| | Modulus at | | | | | |
|---|---|---|---|---|---|---|
| Immersion | 10% | | Tensile | Energy to | | Torsional |
| Time in | Elongation in | Elongation at | Strength at | Break in | Tear Strength | Modulus in |
| Hours | psi | Break in % | Break in psi | lb_{f}-in | in lb_{f}/in | psi |
| 0 | 112 | 127 | 49 | 0.43 | 3.8 | 7.5 |
| 2600 | 136 | 104 | 52 | 0.33 | 2.0 | 10.7 |

The observed insignificant change in physical properties over time demonstrates that the composite material has stable properties when stored in sealed plastic bags.

### Example 2

One of the lures made in Example 1 was weighed and found to have a mass of 7.566 grams and a head diameter of 0.375 inches. The lure was thereafter immersed in a small vessel containing deionized water. After two hours the lure was removed from the water, surface dried with a paper towel and weighed. The swollen lure had a 9% mass gain and the head diameter had increased by 7%. The water in the container had film droplets on its surface indicating that the menhaden oil had diffused out of the lure and collected on the water's surface during the two hours of water immersion. After three more hours of water immersion in a new clean container having new deionized water, the swollen lure was again removed from the water, dried and weighed. The lure now had a 14% mass gain and the head diameter increase was the same, 7%. The water in the container again had film droplets on its surface, showing that the menhaden oil had continued to diffuse out of the lure during the additional three hours of water immersion. After 22 more hours of water immersion in a new clean container having new deionized water, the swollen lure was again removed from the water, dried and weighed. The lure now had a 26% mass gain and the head diameter had increased by 15%. The water in the container again had film droplets on its surface, showing that the menhaden oil had continued to diffuse out of the lure during the additional 22 hours of water immersion.

The gain in the lure weight and increase in head diameter over 27 hours of water immersion reveals that the composite material forming the lure had absorbed water. These results show that the composite material forming the lure is hydrophilic and its swollen structure allows sustained diffusion of the menhaden oil fish attractant into the surrounding water.

After attachment of a hook, the worm lures made in Example 1 were used to catch several fish from a fresh water lake during three hours of fishing. These lures gave the hooking and lure movement in water properties desired by fishermen. The lures were usable throughout this time period even after being hooked, cast and trolled many times. These results show that the composite material has maintained sufficient physical properties during three hours of fishing.

### Example 3

Some of the circular disks made in Example 1 were used to determine the change in composite physical properties with immersion in lake fresh water at room temperature conditions for various times, After water immersion, the swollen disks were used to make physical test samples. The test samples were used to measure the ASTM properties listed in Example 1. Results are given in Table II.

TABLE II
Changes in Composite Physical Properties after Immersion in Lake Water

| | Modulus at | | | | | |
|---|---|---|---|---|---|---|
| Immersion | 10% | | Tensile | Energy to | | Torsional |
| Time in | Elongation in | Elongation at | Strength at | Break in | Tear Strength | Modulus in |
| Hours | psi | Break in % | Break in psi | lb_{f}-in | in lb_{f}/in | psi |
| 0 | 112 | 127 | 49 | 0.43 | 3.8 | 7.5 |
| 24 | 128 | 85 | 44 | 0.35 | 2.3 | 14.1 |
| 200 | 195 | 81 | 65 | 0.45 | 3.3 | 15.8 |
| 2600 | 117 | 95 | 49 | 0.34 | 0.5 | 12.2 |

The increase in the torsional modulus after one day of water immersion is due to the exchange of plasticizer and fish oil within the composite with water. The decline in physical properties with continued water immersion demonstrates that the composite material gradually degrades in lake fresh water.

### Example 4

A composite lure material was made by melt mixing, in a co-rotating twin screw extruder at 210° C., 12 weight parts of Hytrel® 8171 copolyester and 12 weight parts of Biomax® 4026 copolyester, both produced by DuPont, Wilmington, Del., 36 weight parts of AQ® WDP-400 copolyester, produced by Eastman Chemical Co., Kingsport, Tenn., 28 weight parts of Citroflex® C2 citric acid ester plasticizer, produced by Morflex, Inc., Greensboro, N.C., and 12 weight parts of menhaden fish oil coplasticizer and fish attractant produced by GloryHole Fishing Products, Boyd, Tex. The composite material was molded into ⅜ inch diameter by five inch long worm like fishing lures and 1/16 inch thick by 5 inches in diameter flat, circular disks. The circular disks were used to make physical test samples.

Some of the circular disks made in Example 4 were used to determine the change in composite physical properties after immersion in lake fresh water at room temperature conditions for various times. After water immersion, the swollen disks were used to make physical test samples. The test samples were used to measure the ASTM properties as described in Example 1. Results are given in Table III:

TABLE III
Changes in Composite Physical Properties After Immersion in Lake Water

| | Modulus at | | | | | |
|---|---|---|---|---|---|---|
| Immersion | 10% | | Tensile | Energy to | | Torsional |
| Time in | Elongation in | Elongation at | Strength at | Break in | Tear Strength | Modulus in |
| Hours | psi | Break in % | Break in psi | lb_{f}-in | in lb_{f}/in | psi |
| 0 | 82 | 88 | 17.9 | 0.130 | 1.8 | 3.9 |
| 18 | 31 | 20 | 3.6 | 0.007 | 0.15 | 1.0 |
| 1000 | 29 | 24 | 6.1 | 0.010 | Note #1 | 0.7 |

Note #1: Samples were so physically weak that measurements could not be made because test samples could not be made or handled without damage.

As shown in Table III, after limited water exposure the composites had very weak cohesive properties and showed delamination. The rapid decline in physical properties with continued water immersion shows that this composite material degrades very quickly in lake water. Comparison of the water immersion results from Example 1 samples in Table II and Example 4 samples in Table III demonstrate that composite composition can be adjusted to control both physical properties and rate of material degradation when placed in water.

### Example 5

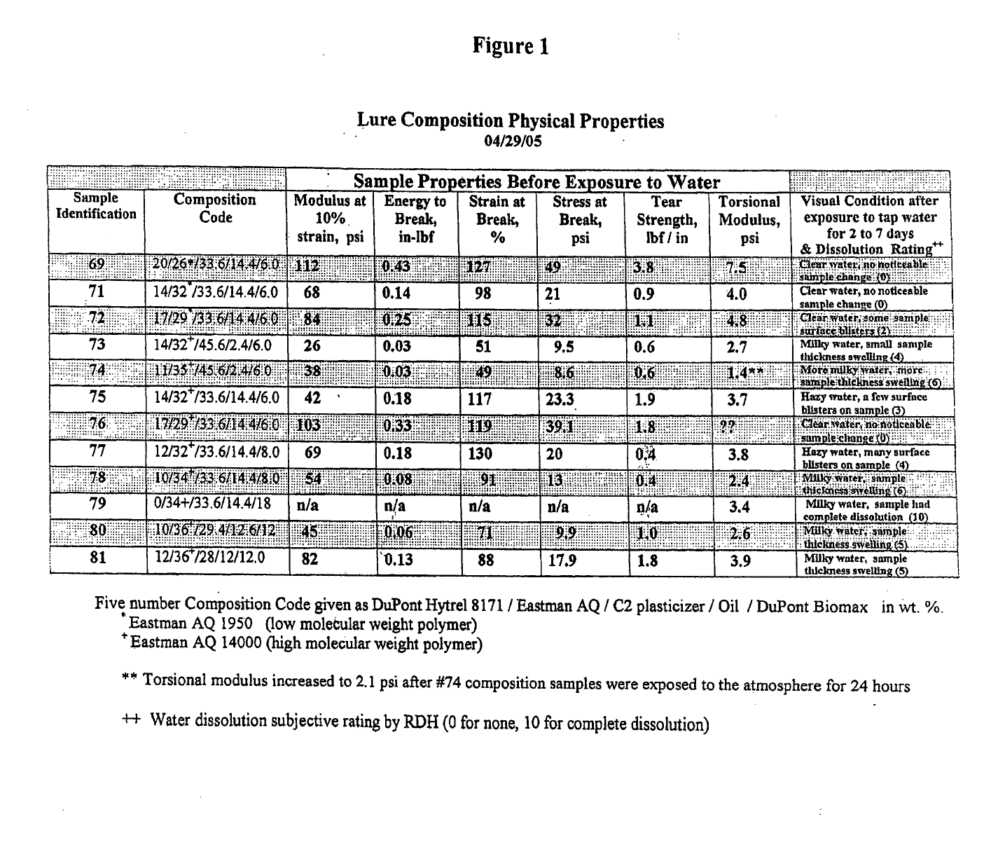

Various composite lure materials were made by melt mixing Hytrel® 8171 copolyester, Biomax® 4026 copolyester, a high or low molecular weight AQ® copolyester, Citroflex® C2 citric acid ester plasticizer and menhaden fish oil coplasticizer/fish attractant in a co-rotating twin screw extruder at 210° C. Each composite material was molded into 1/16 inch thick by 5 inches in diameter flat, circular disk. The circular disks were used to determine the change in composite physical properties before and after immersion in lake fresh water at room temperature conditions for various times. After water immersion, the swollen disks were used to make physical test samples. The test samples were used to measure the ASTM properties as described in Example 1. FIGURE 1 shows the results before water immersion, and also provides a rating of the visual condition of the samples after exposure to tap water. The results for sample #69 after immersion in pond water are shown in Table II, above, and the results for sample #81 after immersion in pond water are shown in Table III, above.

Applicants specifically incorporate the entire contents of all cited references in this disclosure. Further, when an amount, concentration, or other value or parameter is given as either a range, preferred range, or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

Other embodiments of the present teachings will be apparent to those skilled in the art from consideration of the specification and practice of the present teachings disclosed herein. It is intended that the specification and examples be considered as exemplary only, with the true scope and spirit of the present invention being indicated by the following claims and equivalents thereof.

What is claimed is:

1. A fishing lure comprising a body that comprises at least one aliphatic-aromatic copolyester and at least one plasticizer and wherein the body is degradable over time upon immersing the body in water.

2. The fishing lure of claim 1, wherein the body further includes at least one fish attractant.

3. The fishing lure of claim 1, wherein the body includes a first aliphatic-aromatic copolyester of a first defined average molecular weight and a second aliphatic-aromatic copolyester of second defined molecular weight, wherein the first molecular weight is at least 25% greater than the second molecular weight.

4. The fishing lure of claim 3, wherein the first aliphatic-aromatic copolyester is a linear copolyester of polybutylene terphthalate and a polyether glycol and the second aliphatic-aromatic copolyester is a linear polyethylene terphthalate copolymer.

5. The fishing lure of claim 3, wherein the first aliphatic-aromatic copolyester has an average molecular weight of from about 3,000 to about 6,000.

6. The fishing lure of claim 3, wherein the second aliphatic-aromatic copolyester has an average molecular weight of from about 8,000 to about 20,000.

7. The fishing lure of claim 1, wherein the body further includes a branched copolyester containing ionic moieties.

8. The fishing lure of claim 7, wherein the branched copolyester has an average molecular weight of from about 1,000 to about 10,000.

9. The fishing lure of claim 7, wherein the branched copolyester is a branched aliphatic-aromatic polyester having randomly distributed pendant sodiosulfo groups.

10. The fishing lure of claim 1, wherein the at least one aliphatic-aromatic copolyester and at least one plasticizer are contained in the body at a ratio by weight of from about 2:3 to about 3:2.

11. The fishing lure of claim 1, wherein the at least one aliphatic-aromatic copolyester and at least one plasticizer are contained in the body at a ratio by weight of from about 8:10 to about 12:10.

12. The fishing lure of claim 1, wherein the at least one plasticizer is a citric acid ester.

13. The fishing lure of claim 1, wherein the at least one plasticizer is a hydrogenated wood rosin ester.

14. The fishing lure of claim 2, wherein the at least one fish attractant is hydrolyzed fish protein, fish oil, fish meal, ground crustaceans, ground mussels, fish powder, fruit, spices, garlic, garlic oil, glitter materials, coloring agents, or any combinations thereof.

15. The fishing lure of claim 2, wherein the at least one fish attractant is a scent that is released in active form upon immersing the body in water.

16. The fishing lure of claim 6, wherein a rate at which the body degrades upon immersion of the body in water is selected by relative amounts of the first aliphatic-aromatic copolyester, the second aliphatic-aromatic copolyester, the branched copolyester containing ionic moieties and the at least one plasticizer.

17. The fishing lure of claim 3, wherein at least one fish attractant is present and the rate at which the at least one fish attractant is released in active form upon immersing the body in water is selected by selecting the relative amounts of the first aliphatic-aromatic copolyester, the second aliphatic-aromatic copolyester, the at least one plasticizer, and the fish attractant.

18. The fishing lure of claim 1, wherein the body has an initial tensile strength at break, and wherein a tensile strength at break after the body is immersed in fresh water at a temperature of 25° C. for 24 hours is within at least 90% of the initial tensile strength at break and wherein a tensile strength at break after the body is immersed in fresh water at a temperature of 25° C. for 2600 hours is less than 90% of the initial tensile strength at break.

19. The fishing lure of claim 1, wherein the body has an initial tear strength, and wherein a tear strength after the body is immersed in fresh water at a temperature of 25° C. for 24 hours is within at least 60% of the initial tear strength and wherein a tear strength after the body is immersed in fresh water at a temperature of 25° C. for 2600 hours is less than 50% of the initial tear strength.

20. The fishing lure of claim 1, wherein the body has an initial modulus at 10% elongation, and wherein a modulus at 10% elongation after the body is immersed in fresh water at a temperature of 25° C. for 24 hours is within at least 90% of the initial modulus at 10% elongation and wherein a modulus at 10% elongation after the body is immersed in fresh water at a temperature of 25° C. for 2600 hours is less than 90% of the initial modulus at 10% elongation.

21. The fishing lure of claim 1, wherein the body has an initial elongation at break, and wherein an elongation at break after the body is immersed in fresh water at a temperature of 25° C. for 24 hours is within at least 80% of the initial elongation at break and wherein an elongation at break after the body is immersed in fresh water at a temperature of 25° C. for 2600 hours is less than 80% of the initial elongation at break.

22. The fishing lure of claim 1, wherein the body has an initial energy to break, and wherein an energy to break after the body is immersed in fresh water at a temperature of 25° C. for 24 hours is within at least 80% of the initial energy to break and wherein an energy to break after the body is immersed in fresh water at a temperature of 25° C. for 2600 hours is less than 70% of the initial energy to break.

23. The fishing lure of claim 15, wherein the body has an initial percent content of fish attractant, and wherein a percent content of fish attractant after the body is immersed in fresh water at a temperature of 25° C. for 24 hours is within at least 90% of the initial percent content of fish attractant and wherein a percent content of fish attractant after the body is immersed in fresh water at ambient temperature for 2600 hours is less than 90% of the initial percent content of fish attractant.

24. A water-degradable fishing lure comprising a water-degradable body having an initial tensile strength at break of from about 40 to about 50 psi, an initial tear strength of from about 3.5 to about 4.0 lb_{f}/inch, an initial modulus at 10% elongation of from about 110 to about 125 psi, an initial elongation at break of from about 120 to about 130%, and an initial energy to break of from about 0.40 to about 0.45 in-lb_{f}, and wherein after the body is immersed in fresh water at 25° C. for 24 hours, the body has a tensile strength at break of from about 40 to about 50 psi, a tear strength of from about 2.2 to about 2.5 lb_{f}/inch, a modulus at 10% elongation of from about 120 to about 130%, an elongation at break of from about 80 to about 90%, and an energy to break of from about 0.35 to about 0.40 lb_{f}/inch, and wherein after the body is immersed in fresh water at a temperature of 25° C. for 2600 hours, the body has a tensile strength at break of 45 psi or less, a tear strength of 3.3 lb_{f}/inch or less, a modulus at 10% elongation of 115 or less, an elongation at break of 95% or less, and an energy to break of 0.34 lb_{f}/inch or less.

25. The fishing lure of claim 1, wherein the body has an initial torsional modulus to break, and wherein the torsional modulus to break after the body is immersed in fresh water at a temperature of 25° C. for 24 hours is within at least 80% of the initial torsional modulus to break and wherein the torsional modulus after the body is immersed in fresh water at a temperature of 25° C. for 2600 hours is less than 80% of the initial torsional modulus to break.
